(19) United States
(12) Patent Application Publication
(10) Pub. No.: US 2025/0307343 A1
(43) Pub. Date: Oct. 2, 2025

(54) TENSOR PROCESSING UNIT WITH CONFIGURABLE HARDWARE

(71) Applicant: Microsoft Technology Licensing, LLC, Redmond, WA (US)

(72) Inventor: Nitin Naresh GAREGRAT, San Jose, CA (US)

(21) Appl. No.: 18/622,637

(22) Filed: Mar. 29, 2024

(51) Int. Cl. G06F 15/80; G06F 9/30

(52) U.S. Cl. CPC G06F 17/153; G06F 9/3001; G06F 15/8046

(57) ABSTRACT

Various embodiments described herein dynamically control circuitry in a tensor processing unit (TPU) to efficiently cause arithmetic logic units (ALUs) to perform artificial intelligence (AI)-based operations, such as those involving matrix-matrix operations. Circuitry in the TPU is controlled based on a determination that ALUs are arranged to perform certain dot product operations over a plurality of clock cycles and that a subset of ALUs do not perform a dot product operation during a first clock cycle of the plurality of clock cycles. Controlling the circuitry in the TPU causes the TPU to repurpose the ALUs to cause at least a portion of the subset of ALUs to perform, during the first clock cycle, at least one dot product operation of the plurality of dot product operations. In this manner, more neural network operations can be performed per clock cycle, thereby improving computational efficiency, speed, and throughput using TPUs.

### BACKGROUND

Performing computations, workloads, or tasks in a distributed environment, such as a “cloud computing system” or the “cloud,” generally represents a transformative paradigm in computing that leverages the power of remote data centers to perform complex computing tasks. An example of complex computing workflows or tasks includes those associated with artificial intelligence (AI). Accessibility to AI has been facilitated by the widespread adoption of the cloud, which has evolved in response to the increasing demand for computational resources that exceed the computational resources available on individual devices running locally on-premises. Recent widespread adoption of AI-related tasks has caused the demand for computational resources provided by certain distributed environments to increase. For example, running AI-based computations includes processing raw data, initializing AI models, iteratively training the AI models, validating the AI models, deploying the trained and validated AI models, and performing inferences associated with user requests made against these deployed AI models. Certain AI-based computations are implemented as matrix operations (for example, matrix multiplication). As the dimensionality of these matrices increases disproportionately with the other dimension of the matrix due to computational complexities, certain existing hardware inefficiently utilizes computational resources to perform matrix multiplication on these higher-dimensionality matrices.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Various embodiments described herein dynamically control circuitry in a tensor processing unit (TPU) to more efficiently cause arithmetic logic units (ALUs), such as accumulators and/or dot product units (among other ALUs), to perform artificial intelligence (AI)-based operations, such as those involving a matrix-matrix operation. The circuitry in the TPU is controlled based on a determination that ALUs are arranged to perform certain dot product operations over a plurality of clock cycles and that a subset of ALUs do not perform a dot product operation during a first clock cycle of the plurality of clock cycles. That is, the subset of ALUs would remain unused and not perform a dot product operation absent the circuitry in the TPU being controlled. Controlling the circuitry in the TPU causes at least a portion of the subset of ALUs to perform, during the first clock cycle, at least one dot product operation of the plurality of dot product operations that would otherwise not be performed in the first clock cycle absent the embodiments disclosed herein. In this manner, more neural network operations can be performed per clock cycle, thereby improving computational efficiency, speed, and throughput using TPUs.

Embodiments of the TPU include one or more matrix computation units (MCUs) including an N×M array of arithmetic logic units (ALUs) (also referred to in one example as “dot product units” or “accumulators”), such that N and M is a respective positive integer greater than two. Using certain existing techniques, a matrix-matrix operation, such as matrix multiplication, is inefficiently performed for certain tall matrices, wide matrices, or other matrices having dimensions not matching the dimensions of the MCU. Embodiments of controlling the circuitry in the TPU, as described herein, improve the inefficient use of the array of ALUs performing a matrix multiplication or other neural network operation. For example and as described herein, suppose the MCU accesses two matrices, B and A, where B is an X by (“x”) K matrix and A is K×Y matrix to perform a matrix multiplication of the two matrices. In this example, suppose the MCU includes M×N number of ALUs, each configured to perform a 1×K vector multiplied with K×1 associated with the two matrices, B and A. Certain embodiments disclosed herein facilitate using the MCU and corresponding ALUs to perform a matrix-matrix operation where X is less than N and/or Y is less than M. An example matrix-matrix operation includes multiplication of a vector by a matrix or multiplication of a matrix by vector by controlling circuitry within the MCU.

In one embodiment, controlling circuitry in the TPU causes some of the ALUs to perform an addition operation instead of a dot product operation, thereby causing at least a portion of ALUs that would otherwise remain unused during a first clock cycle to perform, during the first clock cycle, at least one dot product of the plurality of dot products that would otherwise be performed during a later clock cycle. In this manner, more neural network operations can be performed per clock cycle.

In one embodiment, controlling circuitry in the TPU includes dividing a matrix that is part of the matrix multiplication into submatrices and performing the matrix multiplication. In one embodiment, dividing the matrix into submatrices causes the ALU to not be repurposed, thereby efficiently achieving a solution of improved efficiency in using TPUs with minimal disruption to the ALUs.

The present disclosure provides one or more technical solutions that have technical effects in light of various technical problems. Particular embodiments have the technical effect of improved lifespan and operation of hardware components in data centers by reducing the number of clock cycles to perform certain matrix-matrix operations. For example, controlling circuitry in a TPU causes ALUs to be repurposed to cause more ALUs to perform a dot product operation during a particular clock cycle. Further, particular embodiments have the technical effect of saving power and improving computational efficiency in performing computationally expensive operations, such as those associated with performing matrix-matrix operations on matrices having dimensions not matching or being less than a number of ALUs per row or column of the array of ALU. For example, controlling circuitry in a TPU causes ALUs to be repurposed to cause more ALUs to perform a dot product operation during a particular clock cycle to require less clock cycles and corresponding power to achieve quicker outputs. Additionally, certain embodiments have the technical effect of increasing scalability, allowing computing systems to enforce dozens, hundreds, thousands, or even millions of matrix-matrix operations and execute AI-based workflows, such as training, inference, and other neural network operations.

### BRIEF DESCRIPTION OF THE DRAWINGS

The present disclosure is described in detail below with reference to the attached drawing figures, wherein:

FIG. 1 is a block diagram of an example tensor processing unit (TPU) suitable for implementations of the present disclosure;

FIG. 2 is a block diagram of an example architecture for an aspect of the TPU of FIG. 1, in accordance with an embodiment of the present disclosure;

FIG. 3 is a schematic flow diagram of an example matrix-matrix data path associated with a matrix-matrix operation being implemented in conjunction with a matrix computation unit (MCU) including a plurality of arithmetic logic units (ALUs), in accordance with an embodiment of the present disclosure;

FIG. 4 is a schematic flow diagram of an example matrix-matrix data path repurposed as a vector-matrix data path and repurposing at least one ALU to add intermediate results, in accordance with an embodiment of the present disclosure;

FIG. 5 is a schematic flow diagram of an example matrix-matrix data path repurposed as a vector-matrix data path without repurposing the ALUs, in accordance with an embodiment of the present disclosure;

FIG. 6 is a block diagram of a language model that employs AI-based operations to make particular predictions, in accordance with an embodiment of the present disclosure;

FIG. 7 depicts a flow diagram of a method for controlling circuitry in the TPU to cause ALUs to perform a multiply-accumulate (MAC) operation during a clock cycle during which the ALU would remain unused absent the circuitry being controlled, in accordance with an embodiment of the present disclosure;

FIG. 8 depicts a flow diagram of a method for controlling circuitry in the TPU to cause ALUs to perform a multiply-accumulate (MAC) operation during a clock cycle during which the ALU would remain unused absent the circuitry being controlled, in accordance with an embodiment of the present disclosure;

FIG. 9 is a block diagram of an example computing environment suitable for use in implementing an embodiment of the present disclosure; and

FIG. 10 is a block diagram of an example computing device suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

Embodiments of the technology described herein dynamically controlling circuitry within certain application-specific integrated circuits (ASICs), such as a tensor processing unit (TPU), to cause more arithmetic logic units (ALUs) to perform a multiply-accumulate (MAC) operation, instead of remaining unused, during a clock cycle. In one embodiment, one or more ALUs are activated by repurposing one ALU to perform at least one of: a matrix-matrix operation, a matrix-vector operation, a vector-matrix operation, or a vector-vector dot product operation. In one example, a TPU generally refers to an AI accelerator ASIC equipped to handle AI-based computations, including tasks associated with neural network machine learning, such as a training operation or an inference operation. As compared to certain graphics processing units (GPUs) and central processing units (CPUs), certain TPUs are designed for a higher volume of lower-precision computations (for example, 8-bit precision). In this manner, certain TPUs perform more input/output operations per joule as compared to GPUs and CPUs, and without hardware for rasterization or texture mapping.

In one example, an ALU refers to a component of the TPU that is designed for performing MAC operations, dot product operations (for example, on tensors), or any suitable fused arithmetic operation. Example ALUs include a dot product unit, an accumulator, or any suitable component for performing fused arithmetic. For example, a dot product operation performed by an ALU, such as a dot product unit, refers to a multiply-and-sum operation, which can be performed on all corresponding dimensions in the tensor so that the dot product operations outputs a scalar value. Algebraically, an example dot product is the sum of the products of the corresponding entries of the two sequences of numbers. Geometrically, an example dot product is the product of the Euclidean magnitudes of the two vectors and the cosine of the angle between them. In the context of tensors, the inner product between a tensor of order n and a tensor of order m is a tensor of order n+m−2. Due to the ability of TPUs to handle a higher volume of low-precision computations, more recently TPUs have been employed to perform AI-based operations, such as training, validating, error correcting, and so forth, in association with a machine learning model, for example, using a neural network

One example AI-based operation includes a matrix-matrix operation. The computational complexities of these matrix-matrix operations typically vary based on the size of the matrices, the linearity of the computations, the symmetry of the matrix, and so forth. In one example, a matrix refers to a rectangular array or table of numbers, symbols, or expressions, arranged in rows and/or columns and used to represent a mathematical object or a property of such an object. However, embodiments disclosed herein are not limited to matrices, as certain embodiments disclosed herein are applicable to tables, trees, linked trees, heaps, arrays, graphs, stacks, or any suitable high-dimensional data structure.

To help illustrate an example matrix, suppose an X by (“x”) Y matrix has X number of rows and Y number of columns. This example matrix is classified as a “wide matrix” (also referred to in one example as a “big matrix” or a “large matrix”) if X is less than Y, such that the matrix is wider the larger that Y is compared to X. Alternatively or additionally, this example matrix is classified as a “narrow matrix” (also referred to in one example as a “skinny matrix” or a “tall matrix”) if X is greater than Y, such that the matrix is more narrow the larger that X is compared to Y. The type of matrices used in the matrix-matrix operation typically influences the activation of ALUs utilized by the TPUs.

Some existing approaches include building TPUs that are specialized for operations performed using specific matrices. For example, certain data centers include TPUs that are specialized to perform matrix multiplication using wide matrices. However, these specialized TPUs result in low utilization when narrow matrix multiplication is performed. As a result, resource utilization is inefficient, and running these machines becomes power and resource intensive when matrix multiplication on a narrow matrix is performed. To further remedy these issues, certain existing approaches build TPUs that are specialized for other operations. For example, certain data centers include TPUs that are specialized to perform matrix multiplication using narrow matrices. However, these TPUs specialized to perform narrow matrix multiplication can inefficiently expend computational resources in controlling and coordinating the sharding of matrices with the coalescing of the resulting data to generate an output. In one example, “sharding” refers to separating a sub-data structure from a larger data structure, such as separating different rows or columns of information from a matrix and storing the separated rows or columns as new data structures. Indeed, this process of sharding matrices and coalescing resulting data increases computational resource utilization, time to compute, as well as customer cost.

To improve upon hardware processor technology, certain embodiments disclosed herein dynamically control circuitry within certain ASICs, such as TPUs, to cause more arithmetic logic units (ALUs) to perform a multiply-accumulate (MAC) operation, instead of remaining unused, during a clock cycle. In some embodiments, the circuitry is controlled at or near real-time to more efficiently use the ALUs of the TPU by reducing a number of unused ALUs per clock cycle. In one embodiment, more ALUs are activated by repurposing at least one ALU to perform at least one of: matrix-matrix operations, matrix-vector operations, vector-matrix operation, or vector-vector dot product. In this manner, matrix-matrix operations, such as matrix multiplication, can be configured at run-time by a software component to handle operations on any type of matrix, such as a wide matrix, a narrow matrix, or both. As a result, data centers do not need to be configured with various different TPUs, each specialized to handle operations for different types of matrices, which can drastically vary in their sizes and dimensions.

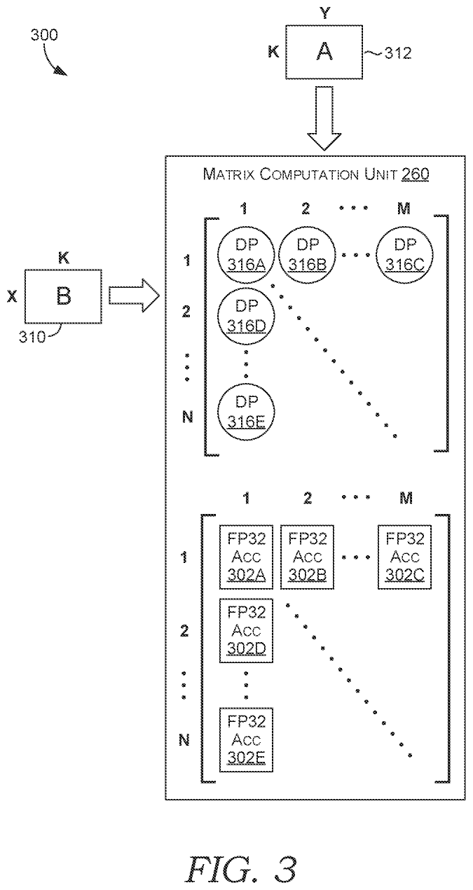

In a first embodiment of controlling circuitry within certain ASICs, a dot product array is repurposed to handle matrix-vector operations. Certain embodiments receive an input indicative of a neural network computer operation. Continuing this example, the TPU determines that an aspect of the computer operation comprises a matrix-matrix operation. An example matrix-matrix operation includes multiplying a first matrix, such as an X×K matrix with a second matrix, such as a K×Y matrix. In this example, X of the first matrix corresponds to the number or dimensionality (for example, the rows) of the first matrix and/or K of the first matrix corresponds to the number or dimensionality (for example, the columns) of the first matrix; and K of the second matrix corresponds to the number or dimensionality (for example, the rows) of the second matrix, and Y of the second matrix corresponds to the number or dimensionality (for example, the columns) of the second matrix. In one embodiment, this example matrix-matrix operation corresponds to a plurality of dot product operations that are assigned to ALUs, such as the dot product units described below with respect to FIGS. 3, 4, and 5. Certain embodiments divide the matrix-matrix operation into a plurality of vector-matrix operations.

In a second embodiment of controlling circuitry within certain ASICs, an array of ALUs is repurposed to handle matrix-vector operations. Certain embodiments receive an input indicative of a computer operation, such as an inference or training operation, to be performed. Certain embodiments determine that an aspect of the computer operation comprises a matrix-matrix operation of at least two matrices, such that the matrix-matrix operation corresponds to a plurality of dot product operations configured to be performed by a plurality of ALUs of the TPU. Certain embodiments determine that the plurality of dot product operations are configured to be performed by the plurality of ALUs over a plurality of clock cycles and that a subset of ALUs of the plurality of ALUs do not perform a dot product operation of the plurality of dot product operations during a first clock cycle of the plurality of clock cycles if circuitry in the TPU is not controlled. Based on this determination, certain embodiments control circuitry in the TPU to repurpose the plurality of ALUs to cause at least a portion of the subset of ALUs to perform, during the first clock cycle, at least one dot product operation of the plurality of dot product operations during a later clock cycle of the plurality of clock cycles.

In a third embodiment of controlling circuitry within certain ASICs, an array of ALUs are not repurposed to handle matrix-vector operations, and instead, at least one matrix used in the matrix-matrix operation is divided into submatrices. Certain embodiments receive, via a TPU, an input indicative of a neural network computer operation to be performed. Certain embodiments determine that an aspect of the computer operation comprises at least one matrix-matrix operation between a first matrix and a second matrix, such that the matrix-matrix operation comprises a plurality of dot product operations performed by a plurality of arithmetic logic units (ALUs) of the TPU. Certain embodiments determine that the plurality of dot product operations are configured to be performed by the plurality of ALUs over a plurality of clock cycles and that a subset of ALUs of the plurality of ALUs do not perform a dot product operation of the plurality of dot product operations during a first clock cycle of the plurality of clock cycles if circuitry in the TPU is not controlled. Based at least on determining that the plurality of dot product operations are configured to be performed over the plurality of clock cycles, certain embodiments divide the at least one matrix-matrix operation into a plurality of vector-matrix operations, for example, by converting the first matrix into a plurality of vectors and converting the second matrix into a plurality of submatrices with a dimensionality of a similar size to that of the number of vectors of the plurality of vectors. Thereafter, certain embodiments controlling circuitry in the TPU to cause at least a portion of the subset of ALUs to perform, during the first clock cycle, at least one dot product operation of the plurality of dot product operations during a later clock cycle of the plurality of clock cycles using the plurality of vectors and the submatrices.

The present disclosure provides one or more technical solutions that have technical effects in light of various technical problems. Particular embodiments have the technical effect of improved lifespan and operation of hardware components in data centers by reducing the number of clock cycles to perform certain matrix-matrix operations. For example, controlling circuitry in a TPU causes ALUs to be repurposed to cause more ALUs to perform a dot product operation during a particular clock cycle. Further, particular embodiments have the technical effect of saving power and improving computational efficiency in performing computationally expensive operations, such as those associated with performing matrix-matrix operations on matrices having dimensions not matching or being less than or not matching a number of ALUs per row or column of the array of ALUs. For example, controlling circuitry in a TPU causes ALUs to be repurposed to cause more ALUs to perform a dot product operation during a particular clock cycle to require less clock cycles and corresponding power to achieve quicker outputs. Additionally, certain embodiments have the technical effect of increasing scalability, allowing computing systems to enforce dozens, hundreds, thousands, or even millions of matrix-matrix operations and execute AI-based workflows, such as training, inference, and other neural network operations.

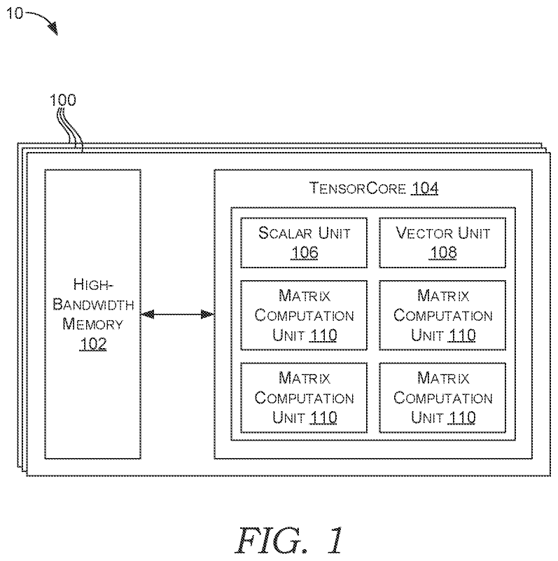

Turning now to FIG. 1, a block diagram is provided showing a TPU assembly 10 including a plurality of example tensor processing unit (TPU) 100 in which some embodiments of the present disclosure can be employed. It should be understood that this and other arrangements described herein are set forth only as examples. Other arrangements and elements (for example, machines, interfaces, functions, orders, and groupings of functions) can be used in addition to or instead of those shown, and some elements can be omitted altogether for the sake of clarity. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, some functions are carried out by a processor executing instructions stored in memory. Additionally, the embodiments disclosed herein are not limited to TPUs, as they may be implemented on other hardware processors, such as other ASICs.

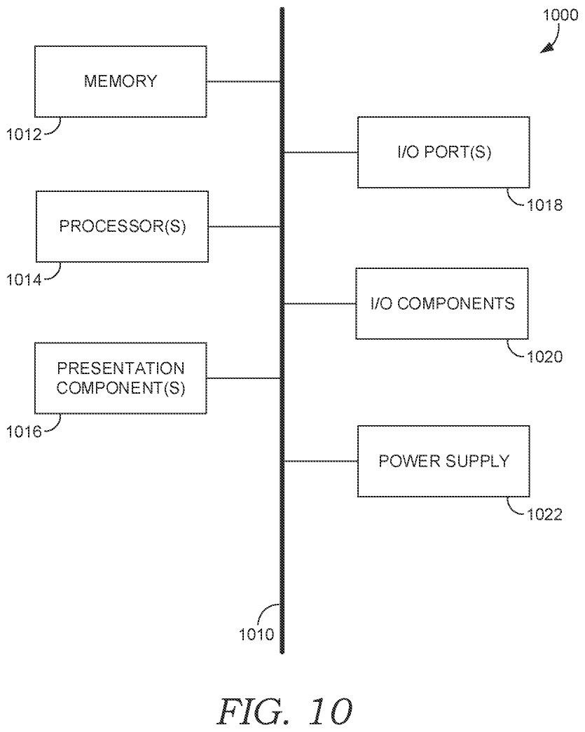

Among other components not shown, example TPU 100 includes a high-bandwidth memory 102 and a tensor core 104 comprising a scalar unit 106, a vector unit 108, and a matrix computation unit (MCU) 110. A group of TPUs 100 can be grouped over a network. For example, a number of TPUs 100 in a TPU pod 10 coordinate computations based on the TPU version. In some embodiments, a virtual machine (REFERENCE FIG. 10) has access to the TPUs 100. For example, a virtual machine (VM) running Linux® has access to the underlying TPUs. In one example, the TPUs 100 correspond to v5 TPUs, such that each VM has access to 1, 4, or 8 TPUs. In another example, the TPUs 100 correspond to v4 TPUs such that each VM accesses 4 TPUs. It should be understood that the VM running any operating system can access any number of TPUs based on the TPU version.

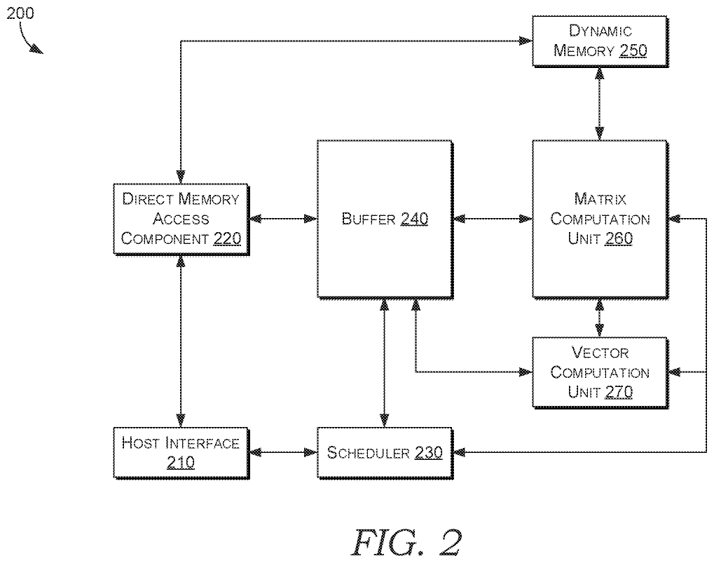

In some embodiments, the high-bandwidth memory 102 corresponds to the memory device 1012 (of FIG. 10), the direct memory access component 220, or the dynamic memory 250 (of FIG. 2). In one embodiment, the high-bandwidth memory 102 is integrated into the TPU. In one embodiment, the high-bandwidth memory 102 supports non-uniform memory access (NUMA). In this manner, each tensor core 104 or corresponding components of the tensor core 104 can directly access data stored on blocks of the high-bandwidth memory 102, thereby supporting parallel computing to increase processing speed and improve computational efficiency. Example high-bandwidth memory 102 contained in TPU 100 corresponding to a v4 TPU includes a unified 32-gibibyte (GiB) memory space, enabling better coordination between a plurality of tensor cores 104.

As illustrated, the TPU 100 contains one or more tensor cores 104. The number of tensor cores 104 depend on the version of the TPU 100. In general, the tensor core is responsible for performing linear algebraic operations. To efficiently perform those operations, embodiments of the tensor core 104 include one or more scalar units 106, one or more vector units 108, and one or more matrix-multiply units (MCUs) 110.

In some embodiments, the scalar unit 106 is a specialized hardware component that efficiently operates on scalar values to perform scalar operations. In one example, scalar values refer to single numeric values, as opposed to vectors or matrices. Example scalar operations performed by the example scalar unit 106 include determining scalar biases in neural network layers, control flow of data, calculating memory addresses, and other maintenance operations, among other operations.

In some embodiments, the vector unit 108 is a specialized hardware component that efficiently operates on vectors to perform vector operations. Vectors, in one example, refer to one-dimensional arrays of numbers. Example vector operations include element-wise operations, activation functions, and other mathematical transformations of data. Certain vector units 108 perform activation computations by applying activation functions element-wise to the elements of the vector. Certain activation functions introduce non-linearities to a neural network, allowing the capture of complex relationships in data. Example activation functions include Rectified Linear Units (ReLUs), Sigmoid functions, and Hyperbolic Tangent (tanh) functions, and softmax functions, to name a few.

In one example, the MCU 110 refers to a specialized hardware component that performs certain linear algebraic operations, such as operations using matrices, including matrix multiplication. Certain MCUs 110 provide the majority (for example, over 50%) of the computing power in certain TPUs 100. In one embodiment the MCU 110 includes any number of accumulators organized in any suitable arrangement. For example, certain MCUs include accumulators arranged in an N×M array, such as 128×32 accumulators arranged in a systolic array, where N corresponds to an arithmetic logic unit (ALU). In one example, a systolic array refers to a homogeneous collection of tight coupled accumulators, such as ALUs, that each independently compute a partial result as a function of data received from upstream neighboring accumulators, stores the result within itself, and passes the result downstream. In one example, the ALUs perform a read operation, an addition operation, a multiplication, a logical AND, and/or registers into which downstream component to put the result. Downstream components can include other MCUs 110, the scalar unit 106, or the vector unit 108. In one example, the MCU contains a 256×256 systolic array of ALUs that includes 65,536 ALUs. In this example, the MCU can process 65,536 multiply-and-add (MAC) operations for 8-bit integers every cycle. Example ALUs 302, such as accumulators and dot product units, are illustrated in FIGS. 3, 4, and 5.

In some embodiments, the MCU 110 performs multiply-accumulate (MAC) operations via corresponding ALUs. In one example, a MAC operation is an operation that involves multiplying two or more numbers and/or adding the product to an accumulator, and then storing the resulting output in the accumulator. Performing certain matrix multiplications involves performing a MAC operation. In one example, the MAC operation efficiently computes the dot product of elements in matrices, speeding up the performing of AI-based operations, such as neural network training and inference.

The illustrated MCU 110 is capable of performing any number of MAC operations per cycle. For example, the MCU 110 performs at least 16,000 MAC operations per cycle. To efficiently perform these MAC operations, the MCU can implement any suitable number format. Example number formats include int8, int16, in32, int64, Bfloat 16, floating point precision (FP) 16, FP 32, and FP 64, among others. For example, certain multiplies of the MAC operation are formatted differently than the accumulations of the MAC operation.

In more detail, FP16, also known as half-precision, generally uses 16 bits to represent a floating-point number. In particular, these 16 bits include a 1-bit sign, a 5-bit exponent, and a 10-bit significand (also called “mantissa” in one example). FP16 provides a smaller range of representable values compared to higher-precision formats but offers faster computations and requires less memory. On the other hand, FP32, also known as single-precision, uses 32 bits to represent a floating-point number. In particular, these 16 bits include a 1-bit sign, an 8-bit exponent, and a 23-bit significand. FP32 provides a wider range of representable values and higher precision compared to FP16. As a result of the higher precision, FP32 provides more precise calculations due to the higher significand.

FIG. 2 depicts a block diagram of an example architecture of a system 200 corresponding to an ASIC, such as the TPU 100 of FIG. 1, in accordance with an embodiment of the present disclosure. In one embodiment, the system 200 performs AI-based computations, such as neural network computations. The system 200 includes a circuit that includes a host interface 210, a direct memory access component 220, a scheduler 230, a buffer 240, a dynamic memory component 250, an MCU 260, and a vector computation unit 270. It should be understood that any of the components illustrated in FIG. 2 can be implemented external to the system 200. The circuitry in system 200 can be controlled to perform the embodiments described herein.

In some embodiments, the host interface 210 receives input instructions that include parameters for a neural network computation. Example parameters include an indication of how many layers should be processed, an indication of corresponding sets of weight inputs for each layer, an indication of an initial set of activation inputs, an indication of the input to the neural network from which the inference is to be computed, a corresponding input and output size of each layer, a type of layer (for example, an input layer, a hidden layer, an output layer, a dense fully connected layer, a convolutional layer, a recurrent layer, a pooling layer, a normalizing layer, a dropout layer, or an activation layer) to be processed.

Certain embodiments of the host interface 210 send the input instructions to a scheduler 230. In some embodiments, the scheduler 230 includes a processor that converts the input instructions into control signals that control the circuit of the system 200 or TPU 100 to perform AI-based computations, such as certain neural network computations. In some embodiments, the scheduler 230 regulates dataflow in the circuit via the control signals. For example, the scheduler directs the sets of weight inputs, the sets of activation inputs, or other input instructions through the circuit. Embodiments of the scheduler 230 send the control signals to a buffer 240, an MCU 260, and a vector computation unit 270 to cause those components to perform matrix-matrix operations, vector-matrix operations, matrix-vector and the like. In some embodiments, the scheduler 230 sends control signals to a direct memory access engine 220 and dynamic memory 250 to access data or cause data to be stored.

In some embodiments, the scheduler 230 generates clock signals. In one example, clock signals are used to cause the components within the TPU 100 or the system 200 to ensure that different units within the TPU operate together to avoid inconsistencies in data processing. For example, the scheduler 230 receives timing of the clock signals to, at appropriate times, send the control signals to each component of the system 200. In some embodiments, the host interface 210 passes in a clock signal from an external processor.

In some embodiments, the host interface 210 sends the sets of weight inputs and the initial set of activation inputs to the direct memory access component 220. In one example, the direct memory access component 220 communicatively couples a main memory component (memory device 1012 of FIG. 10) and the memory space of the TPU (high-bandwidth memory 102 of FIG. 1). For example, the direct memory access component 220 facilitates the accelerated movement of data within system 200, for example, from host interface 210 to the buffer 240 or the dynamic memory 250. In one example, the direct memory access component 220 stores the sets of activation inputs at the buffer 240. In some embodiments, the direct memory access component stores the sets of weights to dynamic memory 250.

In some embodiments, the buffer 240 corresponds to a memory buffer. In one embodiment, the buffer 240 stores the set of activation inputs from the direct memory access engine 220, as well as outputs of the vector computation unit 270. In one embodiment, the vector computation unit 270 corresponds to the vector unit 108 of FIG. 1. The direct memory access engine 220 can access the outputs of the vector computation unit 270 from the buffer 240.

In some embodiments, the dynamic memory 250 and the buffer 240 communicate the sets of weight inputs and the sets of activation inputs, respectively, to the MCU 260. In some embodiments, the MCU 260 is a two-dimensional systolic array. In some embodiments, the MCU 260 is a one-dimensional systolic array or other circuitry that can perform mathematical operations, such as multiplication and addition. In some implementations, the MCU 260 is a general-purpose matrix processor. For example, the MCU 260 includes accumulators arranged in an N×M array, such as 128×32 accumulators arranged in a systolic array, where N corresponds to an arithmetic logic unit (ALU). In one example, the MCU 260 includes the scalar unit 106 (of FIG. 1), the vector unit 108 (of FIG. 1), or the MCU 110 (of FIG. 1).

Embodiments of the MCU 260 process the weight inputs and the activation inputs and provide a vector of outputs to the vector computation unit 270. In one example, the MCU 260 sends the vector of outputs to the buffer 240. In this example, the buffer 240 sends the vector of outputs to the vector computation unit 270. For example, the vector computation unit 270 processes the vector of outputs and stores a vector of processed outputs to the buffer 240. The vector of processed outputs may be used as activation inputs to the MCU 260. For example, the processed outputs are used as activation inputs in a subsequent layer in the neural network.

FIG. 3 is a schematic flow diagram 300 of an example matrix-matrix data path associated with a matrix-matrix operation being implemented in conjunction with an MCU 260 including a plurality of arithmetic logic units (ALUs) 302, in accordance with an embodiment of the present disclosure. As illustrated, the ALUs 302 include FP32 accumulators. However, it should be understood that the embodiments described herein can be implemented by any suitable ALUs implementing any suitable fused arithmetic operation in any suitable number format, such as those described herein, among others. As illustrated, the MCU 260 includes an N×M array of ALUs 302. In more detail, the illustrated MCU 260 includes a first row that includes a first ALU 302A, a second ALU 302B, and a third (or Nth) ALU 302C, as well as a first column that includes the first ALU 302A, a fourth ALU 302D, and a fifth (or Nth) ALU 302E.

As illustrated, a first matrix B (labeled 310) is multiplied with a second matrix A (labeled 312). Embodiments of this disclosure decompose or translate the matrix multiplication of first matrix B with second matrix A into a plurality of dot product operations performed by dot product units 316. As used herein, in one example, the dot product units correspond to a type of ALU. In the illustrated example, the first matrix B is an X×K matrix having X number of rows and K number of columns, and the second matrix A is a K×Y matrix having K number of rows and Y number of columns. Multiplying first matrix B with second matrix A results in a Matrix C based on equation 1 below.

$$C = B \times A = {B}_{s 1} {A}_{t 1} + … + {B}_{sb} {A}_{bt} = {\sum }_{k}^{b} {A}_{sk} {B}_{kt} \qquad ( 1 )$$

In equation 1, s=1 through a and t=1 through c, such that a=dimension of the first matrix B and c=dimension of the second matrix A. That is, matrix multiplication involves performing a dot product operation, via dot product units 316, of each row of the first matrix B with each column of the second matrix A. Thereafter, the resulting values are then summed to form elements of the product matrix. This process can be repeated for each element in the product matrix, such that each element of the product matrix corresponds to a dot product operation (performed by a corresponding dot product unit 316 and) of a row from the first matrix and a column from the second matrix.

In one example, “inner dimensions” in the context of matrix multiplication refers to the number of columns of the first matrix and the number of rows in the second matrix. In the example above, the first matrix B can be multiplied with the second matrix A because the number of columns of the first matrix B equals the number of rows of the second matrix A. Furthermore, in one example, the “outer dimensions” in the context of matrix multiplication refers to the non-inner dimensions of the two matrices, such that the output of the matrix multiplication adopts the outer dimensions of the two multiplied matrices. In this example, the first matrix B is an X×K matrix having X number of rows and K number of columns, and the second matrix A is a K×Y matrix having K number of rows and Y number of columns. In this example, K is the inner dimensions, and X and Y are the outer dimensions. In the illustrated example, multiplying first matrix B with second matrix A results in a Matrix C having X×Y dimensions because matrix multiplication causes the inner dimension of the two matrices multiplied (in this example, K) to be consumed as part of the matrix multiplication.

In some embodiments, the TPU 100 (FIG. 1) determines these dot product operations 316 and assigns one dot product operation to a corresponding ALU, which in this example refers to the dot product unit 316. In this example, the first dot product unit 316A performs a first dot product operation, the second dot product unit 316B performs a second dot product operation, a third dot product unit 316C performs a third dot product operation, the fourth dot product unit 316D performs a fourth dot product operation, and the fifth dot product unit 316E performs a fifth dot product operation. The illustrated ALUs 302, 302B, 302C, 302D, 302E can perform corresponding addition operations, for example.

In one embodiment, the TPU 100 assigns and performs the dot products using at least one of an iterative algorithm, divide-and-conquer algorithm, sub-cubic algorithms, or parallel and distributed algorithms, among other algorithms. In some embodiments, certain ALUs of the N×M array of the ALUs, such as the illustrated dot product units 316, accesses one dot product operation and performs the dot product operation. In examples where the dimensions of the first matrix B and/or second matrix A match the size of the N×M array of ALUs 302 of the MCU 260, the MCU 260 performs the matrix-matrix operation in one clock cycle. That is, when the size of the N×M array of ALUs 302 of the MCU 260 is less than the dimension of the first matrix B with second matrix A (for example, the inner dimensions or outer dimensions), embodiments of the MCU 260 efficiently perform the matrix multiplication of these two matrices by utilizing one entire row or column of the ALUs per clock cycle. However, as discussed above, as the dimensions of the matrices associated with the matrix-matrix operation changes, the matrix-matrix operation is no longer performed in one clock cycle as additional clock cycles are utilized to perform additional dot product operations.

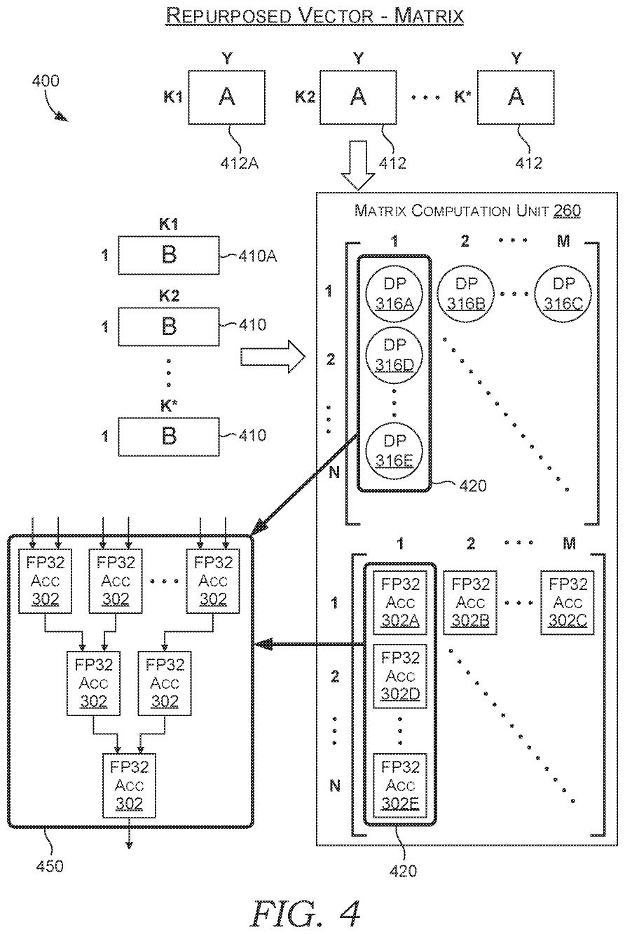

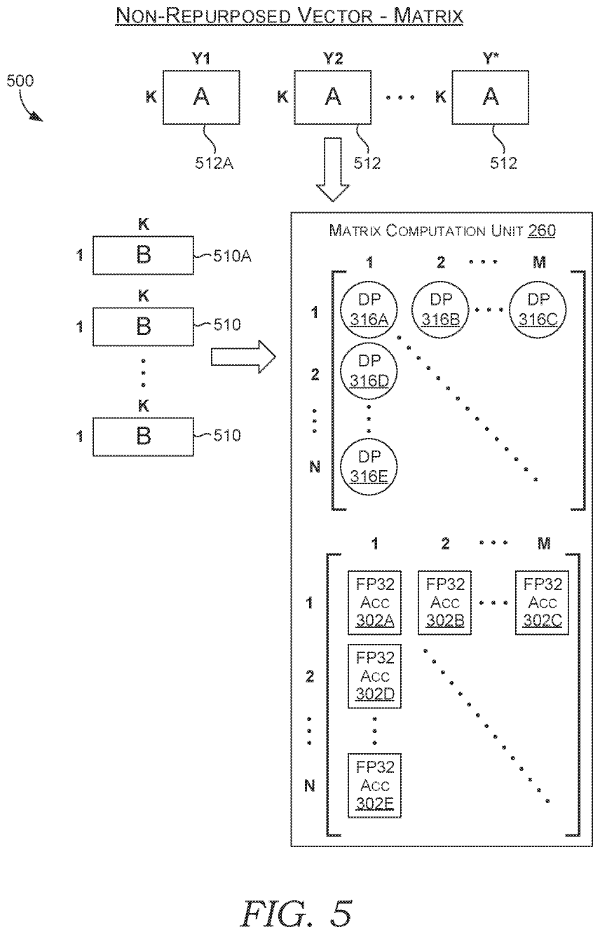

To more efficiently utilize the ALUs available during any one clock cycle, FIGS. 4 and 5 provide an illustration of controlling circuitry in the TPU to repurpose the plurality of ALUs to cause at least a portion of the subset of ALUs to perform, during the first clock cycle, at least one dot product operation of the plurality of dot product operations that would otherwise be performed during a later clock cycle absent the embodiments described herein.

Turning to FIG. 4, illustrated is a schematic flow diagram 400 of an example matrix-matrix data path repurposed as a vector-matrix data path and repurposing at least one ALU 302, such as the illustrated accumulators, to add intermediate results, in accordance with an embodiment of the present disclosure. In some embodiments, a TPU 100 (FIG. 1) receives an input indicative of a neural network computer operation to be performed. In one embodiment, the TPU 100 determines that an aspect of the computer operation comprises at least one matrix-matrix operation between a first matrix B (labeled 310 in FIG. 3) and a second matrix A (labeled 312 in FIG. 3). In one example, the matrix-matrix operation includes a plurality of dot product operations performed by a plurality of arithmetic logic units (ALUs) of the TPU 100, such as the illustrated dot product units 316. In one example, the TPU 100 determines that utilizing the N×M array of ALUs 302 of the MCU 260 would cause the plurality of dot product operations to be performed over a plurality of clock cycles and that a subset of ALUs of the plurality of ALUs remain unused and do not perform a dot product operation of the plurality of dot product operations during a first clock cycle of the plurality of clock cycles.

To more efficiently utilize the ALUs per clock cycle, certain embodiments control circuitry in the TPU to divide at least one matrix-matrix operation into a plurality of vector-matrix operations by converting the first matrix B into a plurality of vectors and converting the second matrix A into a plurality of submatrices with a dimensionality of a similar size to that of the number of vectors of the plurality of vectors. In this example, the TPU divides each row of the first matrix B into a plurality of vectors 410 along inner dimension K, such that each vector 410 corresponds to a portion of the row of first matrix B. Similarly, in this example, the TPU divides each column of second matrix A into submatrices 412 having a number of rows K equal to the number of columns K of the corresponding vector 410. In this example, each vector 410 (for example, row) of the plurality of vectors that forms a row of the vector 410 is multiplied by a corresponding submatrix 412. In this example, these additional dot product operations are performed by an ALU 302 (originally programmed as a dot product unit) during the same clock cycle, instead of performing certain dot product operations at a later clock cycle due to the dimension of the first matrix B or the second matrix A being less than or not matching the size N of the N×M array of ALUs 302 of the MCU 260 of the TPU 100. Certain embodiments of controlling circuitry in the TPU 100 cause at least a portion of the subset of ALUs 302 to perform, during one clock cycle, at least one dot product operation of the plurality of dot product operations (that would otherwise be performed at a later clock cycle) using the plurality of vectors 410 and the submatrices 412.

To help illustrate, suppose that the first column 420 of ALUs 302 is assigned a plurality of MAC operations associated with certain vectors 410 (for example, a portion of a row) of the plurality of vectors forming a row of the first matrix B. In this example, certain vectors 410 are multiplied against a corresponding submatrix 412 of the second matrix A. In this example a first vector 410A, having dimensions 1×K1, is multiplied against a first submatrix 412A having dimensions K1×Y to produce an output having dimensions 1×Y. In one embodiment, causing the ALUs 302 to perform this vector-matrix operation causes the top row of ALUs 302 in the N×M array to be populated. Thereafter, certain ALUs 302, including the certain dot product units 316, are repurposed, as illustrated with respect to the repurposed ALUs 450, to perform an addition operation to cause more dot product operations to be performed in one clock cycle via the N×M array as compared to if these ALUs 302 had not been repurposed. Certain embodiments of the TPU 100 control circuitry to repurpose certain ALUs to perform an addition operation, instead of a default MAC operation. In this manner, certain embodiments cause these intermediate results to be added. As illustrated, at least one ALU 302 of the column 420 is repurposed to perform an addition operation.

Although in this example a row of the first matrix B is divided into a plurality of vectors along inner dimensions, it should be understood that the embodiments discussed herein can be applied to instead divide a column (or row) of the second matrix A along inner dimensions, for example, along a row (or a column) and controlling circuitry to cause the ALUs 302 to be repurposed to add intermediate results. Moreover, in some embodiments, the first matrix B is divided along outer dimensions, and then certain ALUs 302 are repurposed to add intermediate results.

In some embodiments, the ALUs are not repurposed. For example, turning to FIG. 5, illustrated is a schematic flow diagram 500 of an example matrix-matrix data path repurposed as a vector-matrix data path without repurposing the ALUs 302, in accordance with an embodiment of the present disclosure. In some embodiments, a TPU 100 (FIGS. 1 and 2) receives an input indicative of a neural network computer operation to be performed. Example neural network computer operations include a training operation or an inference operation involving a matrix-matrix operation. For example, the TPU 100 determines that an aspect of the computer operation comprises at least one matrix-matrix operation between a first matrix B (labeled 310 in FIG. 3) and a second matrix A (labeled 312 in FIG. 3). In one example, the matrix-matrix operation includes a plurality of dot product operations 316 performed by a plurality of arithmetic logic units (ALUs) 302, including the illustrated dot product units 316, of the TPU 100. In one example, the TPU 100 determines that utilizing the N×M array of ALUs 302 of the MCU 260 would cause the plurality of dot product operations 316 to be performed over a plurality of clock cycles and that a subset of ALUs of the plurality of ALUs would remain unused and do not perform a dot product operation of the plurality of dot product operations during a first clock cycle of the plurality of clock cycles.

To more efficiently utilize the ALUs 302 per clock cycle, certain embodiments control circuitry in the TPU 100 to divide the at least one matrix-matrix operation into a plurality of vector-matrix operations. In one example, the matrix-matrix operation includes multiplying first matrix B and second matrix A. In some embodiments, the matrix-matrix operation is divided based at least on determining that the plurality of dot product operations associated with the matrix-matrix operation are configured to be performed over the plurality of clock cycles. In some embodiments, dividing the at least one matrix-matrix operation includes converting the first matrix B into a plurality of vectors 510A and converting the second matrix A into a plurality of submatrices 512 with a dimensionality of a similar size to that of the number of vectors of the plurality of vectors. In this example, the vectors 510A and the submatrices 512 have similar inner dimensions K. In one example, adding Y1+Y2+ . . . +Y* equals the total number of columns of the second matrix A.

In some embodiments, controlling circuitry in the TPU 100 causes at least a portion of the subset of ALUs 302 or dot product units 316 to perform, during the first clock cycle, at least one dot product operation of the plurality of dot product operations using the plurality of vectors 510 and the submatrices 512. For example, the first vector 510A, having dimensions 1×K, is multiplied with the first submatrix 512A, having dimensions K×Y1, where Y1 is less than the total number of columns of the second matrix A. In this example, multiplying the first vector 510A and the first submatrix 512A outputs a vector of dimensions 1×Y1. In this example, the submatrices 512 are generated to divide the second matrix A into a plurality of submatrices along different columns along the dimension of M (in this example, divide the second matrix A column-wise). In this example, the ALUs 302 are not repurposed. Instead, the dot product units 316 perform a dot product operation as initially configured by circuitry, although the dot product operation in this example is performed using the vectors 510 and submatrices 512. In this manner, controlling circuitry in the TPU 100 causes at least a portion of the subset of ALUs 302 in the N×M array of ALUs 302 to perform, during the first clock cycle, at least one dot product operation of the plurality of dot product operations (that would otherwise be performed at a later clock cycle) using the plurality of vectors 510 and the submatrices 512.

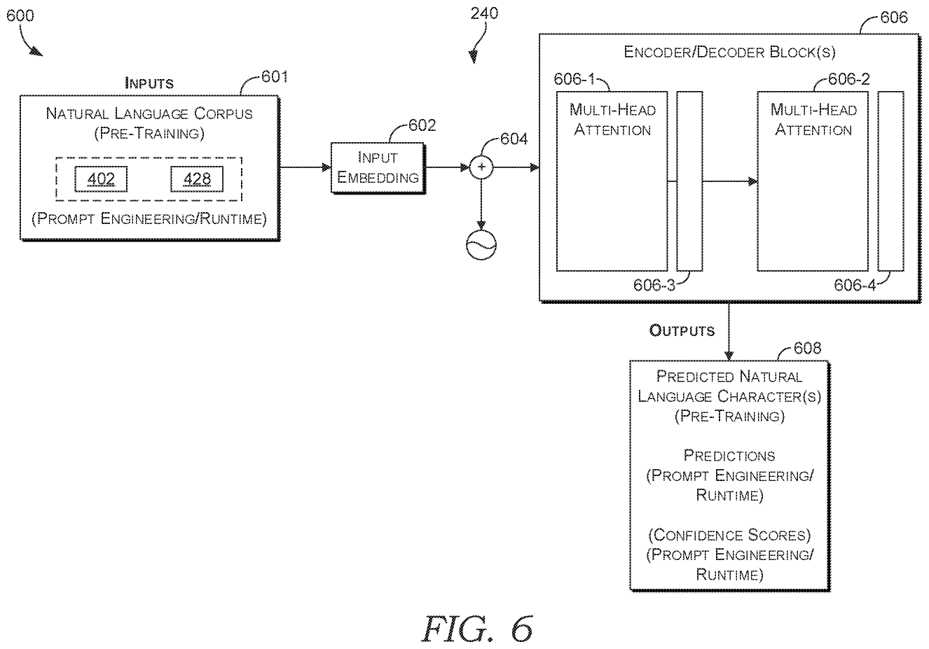

FIG. 6 is a block diagram of a language model 600 (for example, a Bidirectional Encoder Representations from Transformers [BERT] model or Generative Pre-Trained Transformer [GPT]-4 model) that uses particular inputs to make particular predictions (for example, answers to questions), according to some embodiments. Although this example illustrates a prediction operation being performed using the TPU and related embodiments described herein, it should be understood that the TPU and related embodiments described herein can be implemented to perform other neural network operations, such as inferences or training operations. In various embodiments, the language model 600 includes one or more encoders and/or decoder blocks 606 (or any transformer or portion thereof).

To illustrate, first, a natural language corpus (for example, various WIKIPEDIA English words or BooksCorpus) of the inputs 601 are converted into tokens and then feature vectors and embedded into an input embedding 602 to derive meaning of individual natural language words (for example, English semantics) during pre-training. In some embodiments, to understand English language, corpus documents, such as text books, periodicals, blogs, social media feeds, and the like, are ingested by the language model 600.

In some embodiments, each word or character in the input(s) 601 is mapped into the input embedding 602 in parallel or at the same time, unlike existing long short-term memory (LSTM) models, for example. The input embedding 602 maps a word to a feature vector representing the word. But the same word (for example, “apple”) in different sentences may have different meanings (for example, phone versus fruit). This is why a positional encoder 604 can be implemented. A positional encoder 604 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector using the following two example equations:

$${PE}_{( pos , 2 i )} = sin ( pos / 1000 {0}^{2 i / {d}_{model}} ) \qquad ( 2 )$$

$${PE}_{( pos , 2 i + 1 )} = cos ( pos / 1000 {0}^{2 i / {d}_{model}} ) . \qquad ( 3 )$$

After passing the input(s) 601 through the input embedding 602 and applying the positional encoder 604, the output is a word embedding feature vector, which encodes positional information or context based on the positional encoder 604. These word embedding feature vectors are then passed to the encoder and/or decoder block(s) 606, where it goes through a multi-head attention layer 606-1 and a feedforward layer 606-2. The multi-head attention layer 606-1 is generally responsible for focusing or processing certain parts of the feature vectors representing specific portions of the input(s) 601 by generating attention vectors. For example, in Question-Answering systems, the multi-head attention layer 606-1 determines how relevant the ith word (or particular word in a sentence) is for answering the question or relevant to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following equation (4):

$$Z = softmax ( \frac{Q \cdot {K}^{T}}{\sqrt{Dimension of vector Q , K or V}} ) \cdot V . \qquad ( 4 )$$

For multi-headed attention, there are multiple weight matrices W^{q}, W^{k}, and W^{v} so there are multiple attention vectors Z for every word. However, a neural network may expect one attention vector per word. Accordingly, another weighted matrix, W^{z}, is used to make sure the output is still an attention vector per word. This matrix can be processed using the circuitry and embodiments described at least with respect to the schematic flow diagrams 300 and 400 of FIGS. 3 and 4, respectively. For example, the TPU controls internal circuitry to repurpose ALUs 302 (FIG. 3) to cause at least a portion of the subset of ALUs 302 to perform, during the first clock cycle, at least one dot product operation of the plurality of dot product operations that would otherwise be performed in subsequent clock cycles absent the embodiments described herein.

In some embodiments, after the layers 606-1 and 606-2, there is some form of normalization (for example, batch normalization and/or layer normalization) performed to smoothen out the loss surface, making it easier to optimize while using larger learning rates. Layers 606-3 and 606-4 represent residual connection and/or normalization layers where normalization recenters and rescales or normalizes the data across the feature dimensions. The feedforward layer 606-2 is a feedforward neural network that is applied to every one of the attention vectors outputted by the multi-head attention layer 606-1. The feedforward layer 606-2 transforms the attention vectors into a form that can be processed by the next encoder block or make a prediction at 608. For example, given that a document includes first natural language sequence “the due date is . . . ,” the encoder/decoder block(s) 606 predicts that the next natural language sequence will be a specific date or particular words based on past documents that include language identical or similar to the first natural language sequence.

In some embodiments, the encoder/decoder block(s) 606 includes pre-training to learn language (pre-training) and make corresponding predictions. In some embodiments, there is no fine-tuning because some embodiments perform prompt engineering or learning. Pre-training is performed to understand language, and fine-tuning is performed to learn a specific task, such as learning an answer to a set of questions (in Question-Answering [QA] systems).

In some embodiments, the encoder/decoder block(s) 606 learns what language and context for a word is in pre-training by training on two unsupervised tasks (Masked Language Model [MLM] and Next Sentence Prediction [NSP]) simultaneously or at the same time. In terms of the inputs and outputs, at pre-training, the natural language corpus of the inputs 601 may be various historical documents, such as text books, journals, and periodicals, in order to output the predicted natural language characters in 608 (not make the predictions at runtime or prompt engineering at this point). The example encoder/decoder block(s) 606 takes in a sentence, paragraph, or sequence (for example, included in the input[s] 601), with random words being replaced with masks. The goal is to output the value or meaning of the masked tokens. For example, if a line reads, “please [MASK] this document promptly,” the prediction for the “mask” value is “send.” This helps the encoder/decoder block(s) 606 understand the bidirectional context in a sentence, paragraph, or line at a document. In the case of NSP, the encoder/decoder block(s) 606 takes, as input, two or more elements, such as sentences, lines, or paragraphs, and determines, for example, if a second sentence in a document actually follows (for example, is directly below) a first sentence in the document. This helps the encoder/decoder block(s) 606 understand the context across all the elements of a document, not just within a single element. Using both of these together, the encoder/decoder block(s) 606 derives a good understanding of natural language.

In some embodiments, during pre-training, the input to the encoder/decoder block(s) 606 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 602). At the output side is the binary output for the next sentence prediction. For example, this component may output 1, for example, if masked sentence 2 follows (for example, is directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 602) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input[s] 601) that is encoded into a vector (for example, first sentence, second sentence, and so forth, assuming a top-down and right-to-left approach). The position embeddings are vectors that represent the position of a particular word in such a sentence that can be produced by positional encoder 604. When these three embeddings are added or concatenated together, an embedding vector is generated that is used as input into the encoder/decoder block(s) 606. The segment and position embeddings are used for temporal ordering since all of the vectors are fed into the encoder/decoder block(s) 606 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, after pre-training is performed, the encoder/decoder block(s) 606 performs prompt engineering or fine-tuning on a variety of QA data sets by converting different QA formats into a unified sequence-to-sequence format. For example, some embodiments perform the QA task by adding a new question-answering head or encoder/decoder block, just the way a masked language model head is added (in pre-training) for performing an MLM task, except that the task is a part of prompt engineering or fine-tuning. This includes the encoder/decoder block(s) 606 processing the inputs 402 and/or 428, for example, by controlling circuitry in the TPU or dividing matrices as described herein, in order to make the predictions and generate a prompt response, as indicated in 604. Prompt engineering, in one example, is the process of crafting and optimizing text prompts for language models to achieve desired outputs. In other words, prompt engineering comprises a process of mapping prompts (for example, a question) to the output (for example, an answer) that it belongs to for training. For example, if a user asks a model to generate a poem about a person fishing on a lake, the expectation is it will generate a different poem each time. Users may then label the output or answers from best to worst. Such labels are an input to the model to make sure the model is giving more human-like or best answers, while trying to minimize the worst answers (for example, via reinforcement learning). In some embodiments, a “prompt” as described herein includes one or more of: a request (for example, a question or instruction [for example, “write a poem”]), target content, and one or more examples, as described herein.

In some embodiments, the inputs 601 additionally or alternatively include other inputs. In one example, the predictions of the output 606 include any suitable output, such as an inference. Certain embodiments of inputs 402 and/or 428 represent inputs provided to the encoder/decoder block(s) 608 at runtime or after the model 600 has been trained, tested, and deployed. Likewise, in these embodiments, the predictions in the output 608 represent predictions made at runtime or after the model 600 has been trained, tested, and deployed.

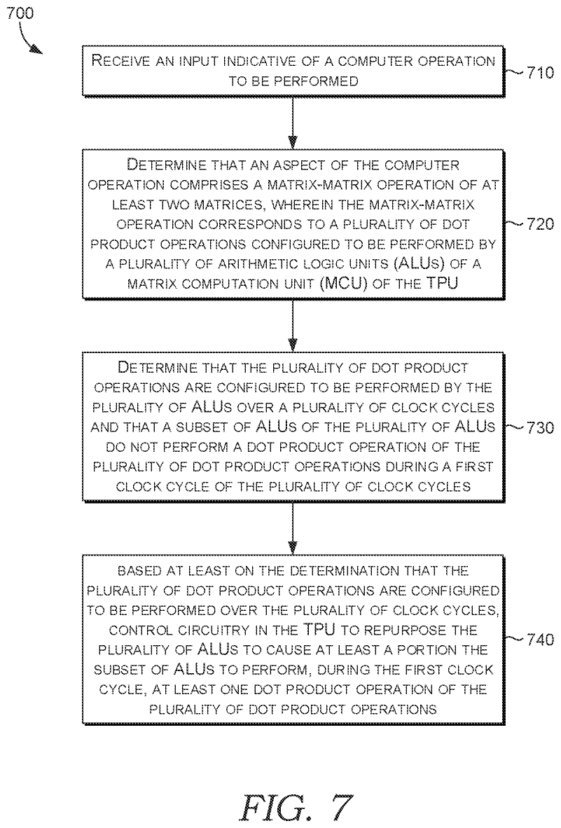

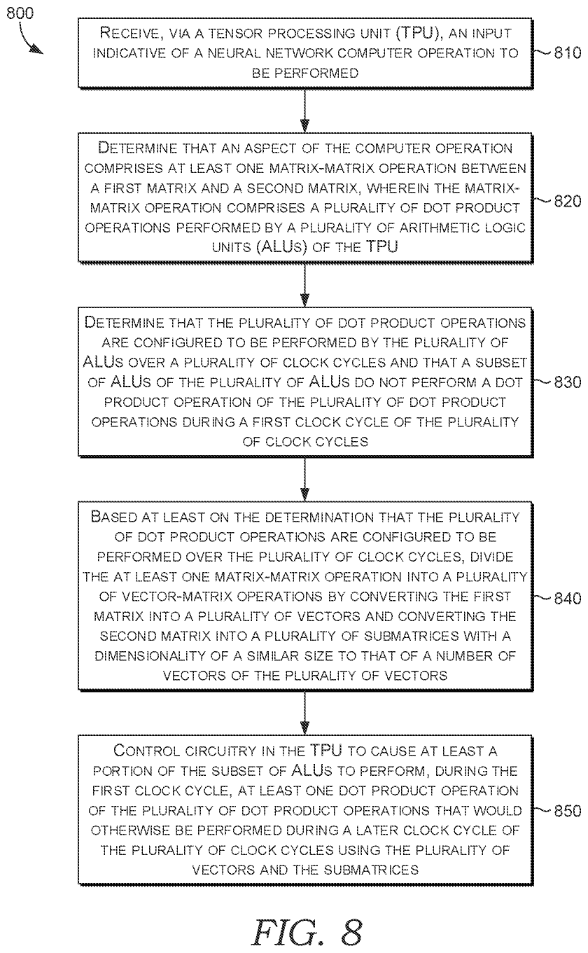

Turning now to FIGS. 7 and 8, aspects of example process flows 700 and 800 are illustratively depicted for some embodiments of the disclosure. Embodiments of process flows 700 and 800 each comprise a method (sometimes referred to herein as method 700 and 800) carried out to implement various example embodiments described herein. For instance, at least one of process flow 700 and 800 is performed to programmatically control circuitry in a TPU 100 (FIG. 1) to cause a portion of ALUs 302 (FIG. 3) to perform, during the first clock cycle, at least one dot product operation 316 (FIG. 3) that would otherwise be performed at a later clock cycle, which is used to provide any of the improved electronic communications technology or enhanced operation of TPUs, as described herein. For example, certain embodiments allow more ALUs 302 to be used per clock cycle, reducing the number of unused ALUs per clock cycle and improving computational speed in performing certain computing operations.

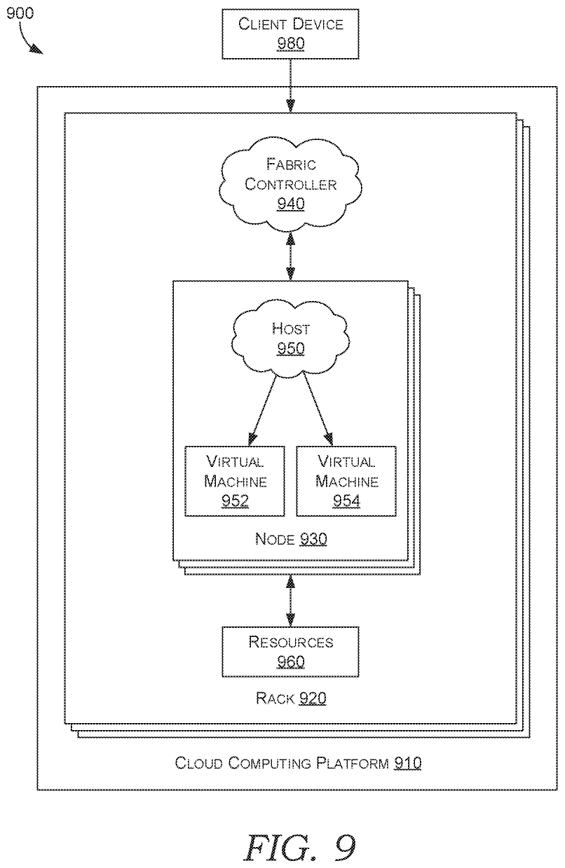

Each block or step of process flow 700, process flow 800, and other methods described herein comprises a computing process performed using any combination of hardware, firmware, and/or software. For instance, various functions are carried out by a processor executing instructions stored in memory, such as memory 1012 as described in FIG. 10. Embodiments of the methods can also be embodied as computer-usable instructions stored on computer storage media. Embodiments of the methods are provided by a standalone application, a service or hosted service (standalone or in combination with another hosted service), or a plug-in to another product, to name a few. For example, the blocks of process flow 700 and 800 that correspond to actions (or steps) to be performed (as opposed to information to be processed or acted on) are carried out by one or more computer applications or services, in some embodiments, which operate on one or more user devices (such as the TPU 100 of FIG. 1), and/or are distributed across multiple user devices, and/or servers, or by a distributed computing platform, and/or are implemented in the cloud, such as is described in connection with FIG. 9. In some embodiments, the functions performed by the blocks or steps of process flows 700 and 800 are carried out by components illustrated in FIG. 1, 2, 3, 4, 5, or 6, for example.

With reference to FIG. 7, aspects of example process flow 700 are illustratively provided controlling circuitry in the TPU to cause ALUs to perform a multiply-accumulate (MAC) operation during a clock cycle during which the ALU would remain unused absent the circuitry being controlled, in accordance with an embodiment of the present disclosure. As illustrated, at block 710, example process flow 700 includes receiving an input indicative of a computer operation to be performed. At block 720, example process flow 700 includes determining that an aspect of the computer operation comprises a matrix-matrix operation of at least two matrices, such that the matrix-matrix operation corresponds to a plurality of dot product operations configured to be performed by a plurality of arithmetic logic units (ALUs) of a matrix computation unit (MCU) of the TPU. At block 730, example process flow 700 includes determining that the plurality of dot product operations are configured to be performed by the plurality of ALUs over a plurality of clock cycles and that a subset of ALUs of the plurality of ALUs do not perform a dot product operation of the plurality of dot product operations during a first clock cycle of the plurality of clock cycles. At block 740, example process flow 700 includes, based at least on the determination that the plurality of dot product operations are configured to be performed over the plurality of clock cycles, controlling circuitry in the TPU to repurpose the plurality of ALUs to cause at least a portion of the subset of ALUs to perform, during the first clock cycle, at least one dot product operation of the plurality of dot product operations.

With reference to FIG. 8, aspects of example process flow 800 are illustratively provided for controlling circuitry in the TPU to cause an ALU to perform a multiply-accumulate (MAC) operation during a clock cycle during which the ALU would remain unused absent the circuitry being controlled, in accordance with an embodiment of the present disclosure. At block 810, example process flow 800 includes receiving, via a tensor processing unit (TPU), an input indicative of a neural network computer operation to be performed. At block 820, example process flow 800 includes determining that an aspect of the computer operation comprises at least one matrix-matrix operation between a first matrix and a second matrix, wherein the matrix-matrix operation comprises a plurality of dot product operations performed by a plurality of arithmetic logic units (ALUs) of the TPU. At block 830, example process flow 800 includes determining that the plurality of dot product operations are configured to be performed by the plurality of ALUs over a plurality of clock cycles and that a subset of ALUs of the plurality of ALUs do not perform a dot product operation of the plurality of dot product operations during a first clock cycle of the plurality of clock cycles. At block 840, example process flow 800 includes, based at least on the determination that the plurality of dot product operations are configured to be performed over the plurality of clock cycles, dividing the at least one matrix-matrix operation into a plurality of vector-matrix operations by converting the first matrix into a plurality of vectors and converting the second matrix into a plurality of submatrices with a dimensionality of a similar size to that of a number of vectors of the plurality of vectors. At block 850, example process flow 800 includes controlling circuitry in the TPU to cause at least a portion of the subset of ALUs to perform, during the first clock cycle, at least one dot product operation of the plurality of dot product operations using the plurality of vectors and the submatrices.

### OTHER EMBODIMENTS

In some embodiments, a system, such as the computerized system described in any of the embodiments above, comprises at least one computer processing unit of a tensor processing unit (TPU); and computer storage media storing computer-useable instructions that, when used by the at least one computer processing unit, cause the system to perform operations. The operations include receiving an input indicative of a computer operation to be performed. The operations include determining that an aspect of the computer operation comprises a matrix-matrix operation of at least two matrices, such that the matrix-matrix operation corresponds to a plurality of dot product operations configured to be performed by a plurality of arithmetic logic units (ALUs) of a matrix computation unit (MCU) of the TPU. The operations include determining that the plurality of dot product operations are configured to be performed by the plurality of ALUs over a plurality of clock cycles and that a subset of ALUs of the plurality of ALUs do not perform a dot product operation of the plurality of dot product operations during a first clock cycle of the plurality of clock cycles. The operations include, based at least on the determination that the plurality of dot product operations are configured to be performed over the plurality of clock cycles, controlling circuitry in the TPU to repurpose the plurality of ALUs to cause at least a portion of the subset of ALUs to perform, during the first clock cycle, at least one dot product operation of the plurality of dot product operations.

In any combination of the above embodiments of the system, repurposing the portion of the subset of ALUs causes more dot product operations to be performed during the first clock cycle than without repurposing the portion of the subset of ALUs.

In any combination of the above embodiments of the system, the matrix-matrix operation comprises multiplication of a first matrix and a second matrix having inner dimensions of equal size. Furthermore, repurposing the portion of the subset of ALUs comprises dividing a row or a column of the first matrix or the second matrix along the inner dimension to create a vector and mapping at least one corresponding dot product operation associated with the vector to the subset of ALUs.

In any combination of the above embodiments of the system, at least one ALU of the plurality of ALUs employs a floating point precision (FP) data format comprising at least one of: FP16, FP 32, or FP64.

In any combination of the above embodiments of the system, the TPU comprises a systolic array comprising of an N×M grid of ALUs, wherein N and M comprises respective values comprising any integer greater than 8.

In any combination of the above embodiments of the system, the plurality of dot product operations are determined to be performed over the plurality of clock cycles based on at least one dimension of a first matrix of the at least two matrices or a second matrix of the at least two matrices being less than or not matching a value of N or M of the N×M grid of ALUs.

In any combination of the above embodiments of the system, the at least one dimension comprises a column of the first matrix and a column of the second matrix.

In any combination of the above embodiments of the system, the operations comprise: determining that an inner dimension of a first matrix of the at least two matrices not matching or being less than a number of available rows or columns of a systolic array comprising the plurality of ALUs; dividing the first matrix along an external dimension into a plurality of submatrices, wherein the plurality of submatrices correspond to a row vector or a column vector of a second matrix, wherein each submatrix of the plurality of submatrices has a dimension substantially equal to a number of ALUs of the ALUs of the available row or column of the plurality of ALUs; assigning each submatrix of the plurality of submatrices and a corresponding row vector or a corresponding column vector to a corresponding ALU of the plurality of ALUs; and performing the matrix-matrix operation based on the plurality of submatrices and the corresponding column vectors or corresponding column vectors of the second matrix being assigned to corresponding ALUs of the plurality of ALUs.

In any combination of the above embodiments of the system, the operations comprise determining that an inner dimension of a first matrix of the at least two matrices does not match or is less than a number of available rows or columns of the plurality of ALUs; dividing the first matrix along the inner dimension into a plurality of vectors, wherein the plurality of vectors correspond to one row or one column of the first matrix, wherein the plurality of vectors have a dimension substantially equal to a number of ALUs of the ALUs of the available row or column of the plurality of ALUs; assigning each of the plurality of vectors and a corresponding submatrix of a second matrix to a corresponding ALU of the plurality of ALUs; and performing the matrix-matrix operation based on the plurality of vectors and a corresponding submatrix of a second matrix to a corresponding ALU of the plurality of ALUs being assigned to corresponding ALUs of the plurality of ALUs.

In any combination of the above embodiments of the system, repurposing the plurality of ALUs comprises causing the subset of ALUs to add intermediate results associated with the at least one dot product operation performed during the first clock cycle.

Various embodiments are directed to computer-implemented methods comprising receiving, via a tensor processing unit (TPU), an input indicative of a neural network computer operation to be performed; determining that an aspect of the computer operation comprises at least one matrix-matrix operation between a first matrix and a second matrix, wherein the matrix-matrix operation comprises a plurality of dot product operations performed by a plurality of arithmetic logic units (ALUs) of the TPU; determining that the plurality of dot product operations are configured to be performed by the plurality of ALUs over a plurality of clock cycles and that a subset of ALUs of the plurality of ALUs do not perform a dot product operation of the plurality of dot product operations during a first clock cycle of the plurality of clock cycles; based at least on the determination that the plurality of dot product operations are configured to be performed over the plurality of clock cycles, dividing the at least one matrix-matrix operation into a plurality of vector-matrix operations or matrix-vector operations by converting the first matrix into a plurality of vectors and converting the second matrix into a plurality of submatrices with a dimensionality equal in size to that of a number of vectors of the plurality of vectors; and controlling circuitry in the TPU to cause at least a portion of the subset of ALUs to perform, during the first clock cycle, at least one dot product operation of the plurality of dot product operations using the plurality of vectors and the plurality of submatrices.

In any combination of the above embodiments of the computer-implemented method, the circuitry is controlled to maintain a MAC operation performed by the plurality of ALUs, wherein the MAC operation comprises an addition operation.

In any combination of the above embodiments of the computer-implemented method, the computer operation comprises an AI-based operation comprising a neural network training operation or a neural network inference operation.

In any combination of the above embodiments of the computer-implemented method, the TPU comprises a systolic array comprising an N×M grid of ALUs, wherein determining that the plurality of dot product operations are configured to be performed by the plurality of ALUs over the plurality of clock cycles comprises determining that a dimension of a row or column of the first matrix or the second matrix is less than a value of N or M of the N×M grid of ALUs.

In any combination of the above embodiments of the computer-implemented method, dividing the at least one matrix-matrix operation into the plurality of vector-matrix operations or vector-matrix operations causes the plurality of ALUs to perform more dot product operations of the plurality of dot product operations than performing the matrix-matrix operation without dividing the at least one matrix-matrix operation.

Various embodiments are directed to one or more computer storage media having computer-executable instructions embodied thereon that, when executed, by one or more processors of a TPU, cause the TPU to perform operations. The operations include accessing an input indicative of a computer operation to be performed; determining that an aspect of the computer operation comprises a matrix-matrix operation of at least two matrices, wherein the matrix-matrix operation corresponds to a plurality of dot product operations configured to be performed by a plurality of arithmetic logic units (ALUs) of the TPU; determining that the plurality of dot product operations are configured to be performed by the plurality of ALUs over a plurality of clock cycles and that a subset of ALUs of the plurality of ALUs do not perform a dot product operation of the plurality of dot product operations during a first clock cycle of the plurality of clock cycles; and based at least on the determination that the plurality of dot product operations are configured to be performed over the plurality of clock cycles, controlling circuitry in the TPU to repurpose the plurality of ALUs to cause at least a portion of the subset of ALUs to perform, during the first clock cycle, at least one dot product operation of the plurality of dot product operations.

In any combination of the above embodiments of the one or more computer storage media, the TPU comprises a systolic array comprising an N×M grid of ALUs.

In any combination of the above embodiments of the one or more computer storage media, the plurality of dot product operations are determined to be performed over the plurality of clock cycles based on at least one dimension of a first matrix of the at least two matrices or a second matrix of the at least two matrices being less than a value of N or a value of M.

In any combination of the above embodiments of the one or more computer storage media, the operations comprise: determining that an inner dimension of a first matrix of the at least two matrices is less than or does not match a number of available rows or columns of the plurality of ALUs; dividing the first matrix along an external dimension into a plurality of submatrices, wherein the plurality of submatrices correspond to a row vector or a column vector of a second matrix, wherein each submatrix of the plurality of submatrices have a dimension substantially equal to a number of ALUs of the ALUs of the available row or column of the plurality of ALUs; assigning each submatrix of the plurality of submatrices and a corresponding row vector or a corresponding column vector to a corresponding ALU of the plurality of ALUs; and performing the matrix-matrix operation based on the plurality of submatrices and the corresponding column vectors or corresponding column vectors of the second matrix being assigned to corresponding ALUs of the plurality of ALUs.

In any combination of the above embodiments of the one or more computer storage media, the operations comprise: determining that an inner dimension of a first matrix of the at least two matrices does not match or is less than a number of available rows or columns of the plurality of ALUs; dividing the first matrix along the inner dimension into a plurality of vectors, wherein the plurality of vectors correspond to one row or one column of the first matrix, wherein the plurality of vectors have a dimension substantially equal to a number of ALUs of the ALUs of the available row or column of the plurality of ALUs; assigning each of the plurality of vectors and a corresponding submatrix of a second matrix to a corresponding ALU of the plurality of ALUs; and performing the matrix-matrix operation based on the plurality of vectors and a corresponding submatrix of a second matrix to a corresponding ALU of the plurality of ALUs being assigned to corresponding ALUs of the plurality of ALUs.

### Example Computing Environments

Having described various implementations, several example computing environments suitable for implementing embodiments of the disclosure are now described, including an example computing device and an example distributed computing environment in FIGS. 8 and 9, respectively. With reference to FIG. 8, an example computing device is provided and referred to generally as computing device 800. The computing device 800 is but one example of a suitable computing environment and is not intended to suggest any limitation as to the scope of use or functionality of embodiments of the disclosure, and nor should the computing device 800 be interpreted as having any dependency or requirement relating to any one or combination of components illustrated.

Embodiments of the disclosure are described in the general context of computer code or machine-useable instructions, including computer-useable or computer-executable instructions, such as program modules, being executed by a computer or other machine such as a smartphone, a tablet personal computer (PC), or other mobile device, server, or client device. Generally, program modules, including routines, programs, objects, components, data structures, and the like, refer to code that performs particular tasks or implements particular abstract data types. Embodiments of the disclosure are practiced in a variety of system configurations, including mobile devices, consumer electronics, general-purpose computers, more specialty computing devices, or the like. Embodiments of the disclosure are also practiced in distributed computing environments where tasks are performed by remote-processing devices that are linked through a communications network. In a distributed computing environment, program modules may be located in both local and remote computer storage media, including memory storage devices.

Some embodiments comprise an end-to-end software-based system that operates within system components described herein to operate computer hardware to provide system functionality. At a low level, hardware processors generally execute instructions selected from a machine language (also referred to as machine code or native) instruction set for a given processor. The processor recognizes the native instructions and performs corresponding low-level functions related to, for example, logic, control, and memory operations. Low-level software written in machine code can provide more complex functionality to higher level software. Accordingly, in some embodiments, computer-executable instructions include any software, including low-level software written in machine code, higher level software such as application software, and any combination thereof. In this regard, the system components can manage resources and provide services for system functionality. Any other variations and combinations thereof are contemplated within the embodiments of the present disclosure.

Referring now to FIG. 9, an example distributed computing environment 900 is illustratively provided, in which implementations of the present disclosure can be employed. In particular, FIG. 9 shows a high-level architecture of an example cloud computing platform 910 that can host a technical solution environment or a portion thereof (for example, a data trustee environment). It should be understood that this and other arrangements described herein are set forth only as examples. For example, as described above, many of the elements described herein are implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 900 that includes cloud computing platform 910, rack 920, and node 930 (for example, computing devices, processing units, or blades) in rack 920. The technical solution environment can be implemented with cloud computing platform 910, which runs cloud services across different data centers and geographic regions. Cloud computing platform 910 can implement the fabric controller 940 component for provisioning and managing resource allocation, deployment, upgrade, and management of cloud services. Typically, cloud computing platform 910 acts to store data or run service applications in a distributed manner. Cloud computing platform 910 in a data center can be configured to host and support operation of endpoints of a particular service application. In one example, the cloud computing platform 910 is a public cloud, a private cloud, or a dedicated cloud.

Node 930 can be provisioned with host 950 (for example, operating system or runtime environment) running a defined software stack on node 930. Node 930 can also be configured to perform specialized functionality (for example, computer nodes or storage nodes) within cloud computing platform 910. Node 930 is allocated to run one or more portions of a service application of a tenant. A tenant can refer to a customer utilizing resources of cloud computing platform 910. Service application components of cloud computing platform 910 that support a particular tenant can be referred to as a multi-tenant infrastructure or tenancy. The terms “service application,” “application,” or “service” are used interchangeably with regards to FIG. 9, and broadly refer to any software, or portions of software, that run on top of, or access storage and computing device locations within, a datacenter.

When more than one separate service application is being supported by nodes 930, certain nodes 930 are partitioned into virtual machines (for example, virtual machine 952 and virtual machine 954). Physical machines can also concurrently run separate service applications. The virtual machines or physical machines can be configured as individualized computing environments that are supported by resources 960 (for example, hardware resources and software resources) in cloud computing platform 910. It is contemplated that resources can be configured for specific service applications. Further, each service application may be divided into functional portions such that each functional portion is able to run on a separate virtual machine. In cloud computing platform 910, multiple servers may be used to run service applications and perform data storage operations in a cluster. In one embodiment, the servers perform data operations independently but exposed as a single device, referred to as a cluster. Each server in the cluster can be implemented as a node.

In some embodiments, client device 980 is linked to a service application in cloud computing platform 910. Client device 980 may be any type of computing device, and the client device 980 can be configured to issue commands to cloud computing platform 910. In embodiments, client device 980 communicates with service applications through a virtual Internet Protocol (IP) and load balancer or other means that direct communication requests to designated endpoints in cloud computing platform 910. Certain components of cloud computing platform 910 communicate with each other over a network (not shown), which includes, without limitation, one or more local area networks (LANs) and/or wide area networks (WANs).

With reference to FIG. 10, computing device 1000 includes a bus 1010 that directly or indirectly couples the following devices: memory 1012, one or more processors 1014, one or more presentation components 1016, one or more input/output (I/O) ports 1018, one or more I/O components 1020, and an illustrative power supply 1022. In one example, bus 1010 represents one or more buses (such as an address bus, data bus, or combination thereof). Although the various blocks of FIG. 10 are shown with lines for the sake of clarity, in reality, these blocks represent logical, not necessarily actual, components. For example, a presentation component includes a display device, such as an I/O component. Also, processors have memory. The inventors hereof recognize that such is the nature of the art and reiterate that the diagram of FIG. 10 is merely illustrative of an example computing device that can be used in connection with one or more embodiments of the present disclosure. Distinction is not made between such categories as “workstation,” “server,” “laptop,” or “handheld device,” as all are contemplated within the scope of FIG. 10 and with reference to “computing device.”

Computing device 1000 typically includes a variety of computer-readable media. Computer-readable media can be any available media that can be accessed by computing device 1000 and includes both volatile and non-volatile, removable and non-removable media. By way of example, and not limitation, computer-readable media comprises computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 1000. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1012 includes computer storage media in the form of volatile and/or non-volatile memory. In one example, the memory is removable, non-removable, or a combination thereof. Hardware devices include, for example, solid-state memory, hard drives, and optical-disc drives. Computing device 1000 includes one or more processors 1014 that read data from various entities such as memory 1012 or I/O components 1020. As used herein and in one example, the term processor or “a processer” refers to more than one computer processor. For example, the term processor (or “a processor”) refers to at least one processor, which may be a physical or virtual processor, such as a computer processor on a virtual machine. The term processor (or “a processor”) also may refer to a plurality of processors, each of which may be physical or virtual, such as a multiprocessor system, distributed processing or distributed computing architecture, cloud computing system, or parallel processing by more than a single processor. Further, various operations described herein as being executed or performed by a processor are performed by more than one processor.

Presentation component(s) 1016 presents data indications to a user or other device. Presentation components include, for example, a display device, speaker, printing component, vibrating component, and the like.

The I/O ports 1018 allow computing device 1000 to be logically coupled to other devices, including I/O components 1020, some of which are built-in. Illustrative components include a microphone, joystick, game pad, satellite dish, scanner, printer, or a wireless device. The I/O components 1020 can provide a natural user interface (NUI) that processes air gestures, voice, or other physiological inputs generated by a user. In some instances, inputs are transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1000. In one example, the computing device 1000 is equipped with depth cameras, such as stereoscopic camera systems, infrared camera systems, red-green-blue (RGB) camera systems, and combinations of these, for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

Some embodiments of computing device 1000 include one or more radio(s) 1024 (or similar wireless communication components). The radio transmits and receives radio or wireless communications. Example computing device 1000 is a wireless terminal adapted to receive communications and media over various wireless networks. Computing device 1000 may communicate via wireless protocols, such as code-division multiple access (“CDMA”), Global System for Mobile (“GSM”) communication, or time-division multiple access (“TDMA”), as well as others, to communicate with other devices. In one embodiment, the radio communication is a short-range connection, a long-range connection, or a combination of both a short-range and a long-range wireless telecommunications connection. When referring to “short” and “long” types of connections, certain embodiments do not refer to the spatial relation between two devices. Instead, certain embodiments generally refer to short range and long range as different categories, or types, of connections (for example, a primary connection and a secondary connection). A short-range connection includes, by way of example and not limitation, a Wi-Fi® connection to a device (for example, mobile hotspot) that provides access to a wireless communications network, such as a wireless local area network (WLAN) connection using the 802.11 protocol; a Bluetooth connection to another computing device is a second example of a short-range connection, or a near-field communication connection. A long-range connection may include a connection using, by way of example and not limitation, one or more of code-division multiple access (CDMA), General Packet Radio Service (GPRS), Global System for Mobile Communication (GSM), time-division multiple access (TDMA), and 802.16 protocols.

Example computing devices 1000 comprise any type of computing device capable of use by a user, such as a personal computer (PC), a laptop computer, a mobile device, a smartphone, a smart speaker, a tablet computer, a smart watch, a wearable computer, a personal digital assistant (PDA) device, a virtual-reality (VR) or augmented-reality (AR) device or headset, music player or an MP3 player, a global positioning system (GPS) device, a video player, a handheld communication device, a gaming device or system, an entertainment system, a vehicle computer system, an embedded system controller, a camera, a remote control, an appliance, a consumer electronic device, a workstation, any other suitable computer device, or any combination of these delineated devices.

### Additional Structural and Functional Features of Embodiments of Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the term “set” may be employed to refer to an ordered (i.e., sequential) or an unordered (i.e., non-sequential) collection of objects (or elements), such as machines (for example, computer devices), physical and/or logical addresses, graph nodes, graph edges, functionalities, and the like. As used herein, a set may include N elements, where Nis any positive integer. That is, a set may include 1, 2, 3, . . . . N objects and/or elements, where N is a positive integer with no upper bound. Therefore, as used herein, a set does not include a null set (i.e., an empty set), that includes no elements (for example, N=0 for the null set). A set may include only a single element. In other embodiments, a set may include a number of elements that is significantly greater than one, two, three, or billions of elements. A set may be an infinite set or a finite set. The objects included in some sets may be discrete objects (for example, the set of natural numbers [symbol] ). The objects included in other sets may be continuous objects (for example, the set of real numbers [symbol] ). In some embodiments, “a set of objects” that is not a null set of the objects may be interchangeably referred to as either “one or more objects” or “at least one object,” where the term “object” may stand for any object or element that may be included in a set. Accordingly, the phrases “one or more objects” and “at least one object” may be employed interchangeably to refer to a set of objects that is not the null or empty set of objects. A set of objects that includes at least two of the objects may be referred to as “a plurality of objects.”

As used herein and in one example, the term “subset,” is a set that is included in another set. A subset may be, but is not required to be, a proper or strict subset of the other set that the subset is included within. That is, if set B is a subset of set A, then in some embodiments, set B is a proper or strict subset of set A. In other embodiments, set B is a subset of set A, but not a proper or a strict subset of set A. For example, set A and set B may be equal sets, and set B may be referred to as a subset of set A. In such embodiments, set A may also be referred to as a subset of set B. Two sets may be disjointed sets if the intersection between the two sets is the null set.

As used herein, the terms “application” or “app” may be employed interchangeably to refer to any software-based program, package, or product that is executable via one or more (physical or virtual) computing machines or devices. An application may be any set of software products that, when executed, provide an end user one or more computational and/or data services. In some embodiments, an application may refer to a set of applications that may be executed together to provide the one or more computational and/or data services. The applications included in a set of applications may be executed serially, in parallel, or any combination thereof. The execution of multiple applications (comprising a single application) may be interleaved. For example, an application may include a first application and a second application. An execution of the application may include the serial execution of the first and second application or a parallel execution of the first and second applications. In other embodiments, the execution of the first and second application may be interleaved.

For purposes of a detailed discussion above, embodiments of the present disclosure are described with reference to a computing device or a distributed computing environment; however, the computing device and distributed computing environment depicted herein are non-limiting examples. Moreover, the terms computer system and computing system may be used interchangeably herein, such that a computer system is not limited to a single computing device, nor does a computing system require a plurality of computing devices. Rather, various aspects of the embodiments of this disclosure may be carried out on a single computing device or a plurality of computing devices, as described herein. Additionally, components can be configured for performing novel aspects of embodiments, where the term “configured for” can refer to “programmed to” perform particular tasks or implement particular abstract data types using code. Further, while embodiments of the present disclosure may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system, comprising:
at least one computer processing unit of a tensor processing unit (TPU); and
computer storage media storing computer-useable instructions that, when used by the at least one computer processing unit, cause the system to perform operations comprising:
receiving an input indicative of a computer operation to be performed;
determining that an aspect of the computer operation comprises a matrix-matrix operation of at least two matrices, wherein the matrix-matrix operation corresponds to a plurality of dot product operations configured to be performed by a plurality of arithmetic logic units (ALUs) of a matrix computation unit (MCU) of the TPU;
determining that the plurality of dot product operations are configured to be performed by the plurality of ALUs over a plurality of clock cycles and that a subset of ALUs of the plurality of ALUs do not perform a dot product operation of the plurality of dot product operations during a first clock cycle of the plurality of clock cycles; and
based at least on the determination that the plurality of dot product operations are configured to be performed over the plurality of clock cycles, controlling circuitry in the TPU to repurpose the plurality of ALUs to cause at least a portion of the subset of ALUs to perform, during the first clock cycle, at least one dot product operation of the plurality of dot product operations.

2. The system of claim 1, wherein repurposing the portion of the subset of ALUs causes more dot product operations to be performed during the first clock cycle than without repurposing the portion of the subset of ALUs.

3. The system of claim 1, wherein the matrix-matrix operation comprises multiplication of a first matrix and a second matrix having inner dimensions of equal size, wherein repurposing the portion of the subset of ALUs comprises:
dividing a row or a column of the first matrix or the second matrix along the inner dimension to create a vector; and
mapping at least one corresponding dot product operation associated with the vector to the subset of ALUs.

4. The system of claim 1, wherein at least one ALU of the plurality of ALUs employs a floating point precision (FP) data format comprising at least one of: FP16, FP 32, or FP64.

5. The system of claim 1, wherein the TPU comprises a systolic array comprising of an N×M grid of ALUs, wherein N and M comprises respective values comprising any integer greater than 8.

6. The system of claim 5, wherein the plurality of dot product operations are determined to be performed over the plurality of clock cycles based on at least one dimension of a first matrix of the at least two matrices or a second matrix of the at least two matrices being less than a value of N or M of the N×M grid of ALUs.

7. The system of claim 6, wherein the at least one dimension comprises a column of the first matrix and a column of the second matrix.

8. The system of claim 1, wherein the operations comprise:
determining that an inner dimension of a first matrix of the at least two matrices does not match or is less than a number of available rows or columns of a systolic array comprising the plurality of ALUs;
dividing the first matrix along an external dimension into a plurality of submatrices, wherein the plurality of submatrices correspond to a row vector or a column vector of a second matrix, wherein each submatrix of the plurality of submatrices has a dimension substantially equal to a number of ALUs of the ALUs of the available row or column of the plurality of ALUs;
assigning each submatrix of the plurality of submatrices and a corresponding row vector or a corresponding column vector to a corresponding ALU of the plurality of ALUs; and
performing the matrix-matrix operation based on the plurality of submatrices and the corresponding column vectors or corresponding column vectors of the second matrix being assigned to corresponding ALUs of the plurality of ALUs.

9. The system of claim 1, wherein the operations comprise:
determining that an inner dimension of a first matrix of the at least two matrices does not match or is less than a number of available rows or columns of the plurality of ALUs;
dividing the first matrix along the inner dimension into a plurality of vectors, wherein the plurality of vectors correspond to one row or one column of the first matrix, wherein the plurality of vectors have a dimension substantially equal to a number of ALUs of the ALUs of the available row or column of the plurality of ALUs;
assigning each of the plurality of vectors and a corresponding submatrix of a second matrix to a corresponding ALU of the plurality of ALUs; and
performing the matrix-matrix operation based on the plurality of vectors and a corresponding submatrix of a second matrix to a corresponding ALU of the plurality of ALUs being assigned to corresponding ALUs of the plurality of ALUs.

10. The system of claim 1, wherein repurposing the plurality of ALUs comprises causing the subset of ALUs to add intermediate results associated with the at least one dot product operation performed during the first clock cycle.

11. A computer-implemented method, comprising:
receiving, via a tensor processing unit (TPU), an input indicative of a neural network computer operation to be performed;
determining that an aspect of the computer operation comprises at least one matrix-matrix operation between a first matrix and a second matrix, wherein the matrix-matrix operation comprises a plurality of dot product operations performed by a plurality of arithmetic logic units (ALUs) of the TPU;
determining that the plurality of dot product operations are configured to be performed by the plurality of ALUs over a plurality of clock cycles and that a subset of ALUs of the plurality of ALUs do not perform a dot product operation of the plurality of dot product operations during a first clock cycle of the plurality of clock cycles;
based at least on the determination that the plurality of dot product operations are configured to be performed over the plurality of clock cycles, dividing the at least one matrix-matrix operation into a plurality of vector-matrix operations or matrix-vector operations by converting the first matrix into a plurality of vectors and converting the second matrix into a plurality of submatrices with a dimensionality equal in size to that of a number of vectors of the plurality of vectors; and
controlling circuitry in the TPU to cause at least a portion of the subset of ALUs to perform, during the first clock cycle, at least one dot product operation of the plurality of dot product operations using the plurality of vectors and the plurality of submatrices.

12. The computer-implemented method of claim 11, wherein the circuitry is controlled to maintain a MAC operation performed by the plurality of ALUs, wherein the MAC operation comprises an addition operation.

13. The computer-implemented method of claim 11, wherein the computer operation comprises an AI-based operation comprising a neural network training operation or a neural network inference operation.

14. The computer-implemented method of claim 11, wherein the TPU comprises a systolic array comprising an N×M grid of ALUs, wherein determining that the plurality of dot product operations are configured to be performed by the plurality of ALUs over the plurality of clock cycles comprises determining that a dimension of a row or column of the first matrix or the second matrix is less than a value of N or M of the N×M grid of ALUs.

15. The computer-implemented method of claim 11, wherein dividing the at least one matrix-matrix operation into the plurality of vector-matrix operations or vector-matrix operations causes the plurality of ALUs to perform more dot product operations of the plurality of dot product operations than performing the matrix-matrix operation without dividing the at least one matrix-matrix operation.

16. One or more computer storage media having computer-executable instructions embodied thereon that, when executed by one or more processors of a tensor processing unit (TPU) cause the TPU to perform operations comprising:
accessing an input indicative of a computer operation to be performed;
determining that an aspect of the computer operation comprises a matrix-matrix operation of at least two matrices, wherein the matrix-matrix operation corresponds to a plurality of dot product operations configured to be performed by a plurality of arithmetic logic units (ALUs) of the TPU;
determining that the plurality of dot product operations are configured to be performed by the plurality of ALUs over a plurality of clock cycles and that a subset of ALUs of the plurality of ALUs do not perform a dot product operation of the plurality of dot product operations during a first clock cycle of the plurality of clock cycles; and
based at least on the determination that the plurality of dot product operations are configured to be performed over the plurality of clock cycles, controlling circuitry in the TPU to repurpose the plurality of ALUs to cause at least a portion of the subset of ALUs to perform, during the first clock cycle, at least one dot product operation of the plurality of dot product operations.

17. The one or more computer storage media of claim 16, wherein the TPU comprises a systolic array comprising an N×M grid of ALUs.

18. The one or more computer storage media of claim 16, wherein the plurality of dot product operations are determined to be performed over the plurality of clock cycles based on at least one dimension of a first matrix of the at least two matrices or a second matrix of the at least two matrices being less than a value of N or a value of M.

19. The one or more computer storage media of claim 16, wherein the operations comprise:
determining that an inner dimension of a first matrix of the at least two matrices is less than or does not match a number of available rows or columns of the plurality of ALUs;
dividing the first matrix along an external dimension into a plurality of submatrices, wherein the plurality of submatrices correspond to a row vector or a column vector of a second matrix, wherein each submatrix of the plurality of submatrices have a dimension substantially equal to a number of ALUs of the ALUs of the available row or column of the plurality of ALUs;
assigning each submatrix of the plurality of submatrices and a corresponding row vector or a corresponding column vector to a corresponding ALU of the plurality of ALUs; and
performing the matrix-matrix operation based on the plurality of submatrices and the corresponding column vectors or corresponding column vectors of the second matrix being assigned to corresponding ALUs of the plurality of ALUs.

20. The one or more computer storage media of claim 16, wherein the operations comprise:
determining that an inner dimension of a first matrix of the at least two matrices does not match or is less than a number of available rows or columns of the plurality of ALUs;
dividing the first matrix along the inner dimension into a plurality of vectors, wherein the plurality of vectors correspond to one row or one column of the first matrix, wherein the plurality of vectors have a dimension substantially equal to a number of ALUs of the ALUs of the available row or column of the plurality of ALUs;
assigning each of the plurality of vectors and a corresponding submatrix of a second matrix to a corresponding ALU of the plurality of ALUs; and
performing the matrix-matrix operation based on the plurality of vectors and a corresponding submatrix of a second matrix to a corresponding ALU of the plurality of ALUs being assigned to corresponding ALUs of the plurality of ALUs.
